(19) United States
(12) Patent Application Publication
(10) Pub. No.: US 2005/0248212 A1
(43) Pub. Date: Nov. 10, 2005

(54) Wheel for tire

(76) Inventor: Atsushi Tanno, KANAGAWA (JP)

Correspondence Address: RADER FISHMAN & GRAUER PLLC, LION BUILDING, 1233 20TH STREET N.W., SUITE 501, WASHINGTON, DC, 20036, US

(21) Appl. No.: 10/523,069

(22) PCT Filed: Aug. 19, 2003
(86) PCT No.: PCT/JP03/10443

§ 371 Date: Jan. 27, 2005

(30) Foreign Application Priority Data
Aug. 23, 2002 (JP) 2002-244129

(51) Int. Cl. B60B 21/00

(52) U.S. Cl. 301/95.108

(57) ABSTRACT

A tire wheel comprising a disk and a rim for mounting a pneumatic tire joined to the peripheral edge of the disk. The rim has left and right cylindrical bead seats with a hump which protrudes thereon, and left and right annular rim flanges joined to and extending wheel-radially outwardly from the outer side edges of the bead seats. A ring-like thick element extending along the circumferential direction of the wheel is provided on a portion of the bead seat located between the hump and rim flange of the rim located on the inner side of a vehicle when attached thereto.

### TECHNICAL FIELD

The present invention relates to tire wheels, and more particularly, to a tire wheel which can be lightened without suffering deterioration of road noise.

### TECHNICAL BACKGROUND

In recent years, with lightening of vehicles, tire wheels have been lightened. The ways of lightening include, for example, a way of reducing the thickness of the disc or rim of a wheel.

Tire wheels which are lightened by reducing the thickness of the disc or rim as described above, however, have a lower spring constant, which makes the natural frequency of the wheel move into a lower frequency band, whereby the natural frequency of the wheel is close to the natural frequency of a pneumatic tire assembled to the wheel, resulting in an increase in a resonant action between the two natural frequencies. Therefore there is a problem that road noise is deteriorated.

### DISCLOSURE OF THE INVENTION

An object of the present invention is to provide a tire wheel which can be lightened without suffering deterioration of road noise.

In order to achieve the above object, the present invention provides a tire wheel having a disk and a rim for mounting a pneumatic tire joined to a peripheral edge of the disk, the rim having left and right cylindrical bead seats with a hump which protrudes thereon and left and right annular rim flanges joined to and extending wheel-radially outwardly from outer side edges of the bead seats, wherein a ring-like thick element extending along a circumferential direction of the wheel is provided on a portion of the bead seat located between the hump and rim flange of the rim located on the inner side of a vehicle when attached thereto.

In general, the lightening of wheels makes their spring constants lower, thereby making their natural frequencies move into lower frequency bands. However, by provision of a thick element on the bead seat portion which greatly affects the natural frequency of a wheel, the bead seat portion has a higher rigidity, thereby allowing the bead seat portion which affects the natural frequency to be effectively prevented from repeatedly deforming.

The natural frequency of the lightened wheel which is thin in thickness can therefore be kept in or above a frequency band prior to lightening. Thus, a resonant action between the natural frequencies of the lightened wheel and pneumatic tire attached thereto does not increase, and therefore, road noise is not deteriorated.

The thick element is provided only on the bead seat portion, thus allowing the wheel to be lighter relative to the conventional wheel which is not lightened.

### BRIEF DESCRIPTION OF THE DRAWINGS

FIG. 1 is a half cross-sectional view showing an embodiment of a tire wheel according to the present invention in a wheel-radial cross section taken along a plane which passes through the center axis of rotation of the wheel.

FIG. 2 is a half cross-sectional view showing an alternative embodiment of a tire wheel according to the present invention in a wheel-radial cross section taken along a plane which passes through the center axis of rotation of the wheel.

FIG. 3 is a half cross-sectional view showing another alternative embodiment of a tire wheel according to the present invention in a wheel-radial cross section taken along a plane which passes through the center axis of rotation of the wheel.

FIG. 4 is a half cross-sectional view showing still another alternative embodiment of a tire wheel according to the present invention in a wheel-radial cross section taken along a plane which passes through the center axis of rotation of the wheel.

### BEST MODES FOR CARRYING OUT THE INVENTION

The embodiments of the present invention will be described in detail below with reference to the drawings.

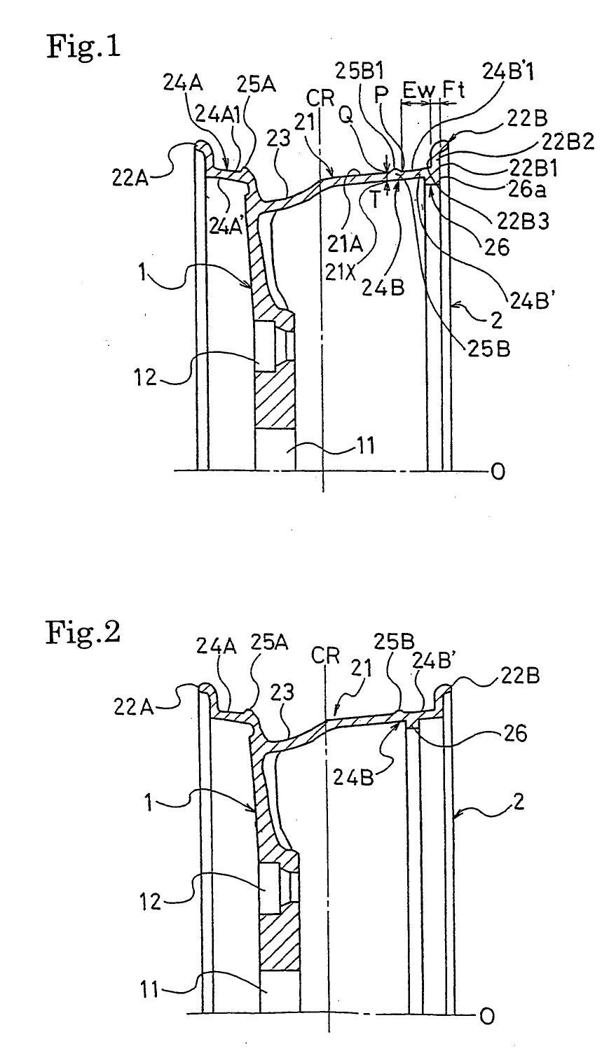

FIG. 1 shows a tire wheel embodying the present invention, in which reference numeral 1 denotes a disk and reference numeral 2 denotes a rim. The disk 1 includes a center portion, which has a hub hole 11 for receiving a hub of an axle. The disk 1 has a plurality of bolt holes 12 for securing the disk 1 to a vehicle in a part surrounding the hub hole 11, the bolt holes 12 being placed in a given interval along the circumferential direction of the disk 1.

The rim 2 for mounting a pneumatic tire is joined to the peripheral edge of the disk 1. The rim 2 comprises a cylindrical rim body 21 joined to the disk 1, and left and right annular rim flanges 22A and 22B joined to both width direction sides of the rim body 21.

The rim body 21 includes a well 23 which is concave in shape, and left and right cylindrical bead seats 24A and 24B which extend from both sides of the well 23, the left and right annular rim flanges 22A and 22B protruding wheel-radially outwardly from the outer side edges of the bead seats 24A and 24B. The disk 1 is offset to one side (the outer side of a vehicle when attached thereto) relative to the width direction center line CR of the rim 2, and the peripheral edge thereof is joined to the well 23.

The bead seats 24A and 24B have humps 25A and 25B, each of which annularly protrudes along the circumferential direction of the wheel on the radially outer surface of each bead seat. The bead seats 24A and 24B have bead seat portions 24A′ and 24B′ between the humps 25A and 25B and the rim flanges 22A and 22B, to which the bead portions of a pneumatic tire are to be fitted.

Provided on the radially inner surface of the bead seat portion 24B′ located between the hump 25B and the rim flange 22B on the other side (the inner side of a vehicle when attached thereto) is a ring-like thick element 26 which extends along the circumferential direction of the wheel. The thick element 26 is integrally formed of the same material as the bead seat portion 24B′ on the radially inner side of the outer side end section of the bead seat portion 24B′ opposite the rim flange 22B. The outer side surface 22B 1 of the rim flange 22B and the outer side surface 26a of the thick element 26 are formed to be in alignment in the substantially same plane.

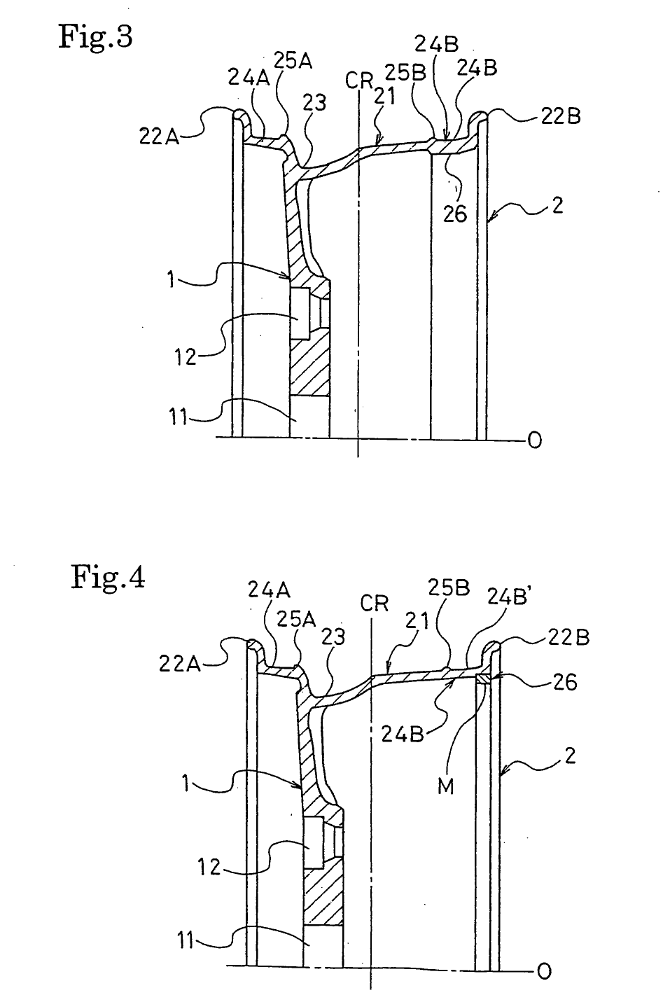

The thick element 26 may be provided, as shown in FIG. 2, on the hump 25B side of the radially inner surface of the bead seat portion 24B′, or may be unitarily formed, as shown in FIG. 3, so as to be thinner over the entire radially inner surface of the bead seat portion 24B′.

The above-mentioned disk 1 and rim 2 are formed of lightweight metal such as an alloy of aluminum or magnesium, and are thinned in thickness, thereby lightening the wheel.

According to the forgoing tire wheel of the present invention, the formation of the ring-like thick element 26 on the bead seat portion 24B′ of the rim located on the inner side of a vehicle when attached thereto makes a spring constant of the bead seat portion higher, and therefore, the deformation of the bead seat portion 24B′ can be inhibited. In general, the lightening of wheels makes their spring constants lower, thereby making their natural frequencies move into lower frequency bands. However, by preventing the bead seat portion 24B′ on the inner side of a vehicle when attached thereto which greatly affects the natural frequency of a wheel, from deforming due to an increase in rigidity, the natural frequency of the lightened wheel can be kept in a frequency band prior to lightening, which is away from the natural frequency of a pneumatic tire.

The natural frequency of the lightened wheel and the natural frequency of a pneumatic tire attached thereto are, therefore, not close to each other, thus avoiding an increase in a resonant action between the natural frequencies of the wheel and pneumatic tire. Accordingly, road noise is not deteriorated.

The thick element 26 is provided only on the bead seat portion 24B′, thus allowing the wheel to be lighter relative to the wheel which is not reduced in thickness.

FIG. 4 shows an alternative tire wheel embodying the present invention. The wheel is constructed such that the thick element 26 shown in FIG. 1 is formed from a ring member M as a separate part, which is fixed to the radailly inner side of the bead seat portion 24B′.

The ring member M may be formed of the same material as the rim 2 (bead seat 24B), and may preferably be formed of a material which is lower in specific gravity and has a rigidity higher than that of the bead seat 24B from the point of view of lightening and improvement of road noise. Such material may preferably include, for example, an alloy of magnesium when the rim 2 is formed of an alloy of aluminum. It will be appreciated that the material used for ring member M may be a material which is lower in specific gravity or has a rigidity higher than that of the bead seat 24B.

The ring member M can be fixed by welding, press fitting, casting or the like. The formation of the thick element 26 by fixing the ring member M comprised of a separate part as described above can obtain the same effect.

In the present invention, the cross-section area of the thick element 26 may be 0.1 to 4.0 times larger than that represented by the product E×T in a wheel-radial cross section taken along a plane which passes through the center axis O of rotation of the wheel, wherein E is a sum of the thickness Ft of the rim flange 22B located on the inner side of a vehicle when attached thereto and the wheel width direction length Ew of the bead seat portion 24B′, and T is a thickness of the portion 21X of the rim body 21 adjacent to the hump 25B located on the inner side of a vehicle when attached thereto, as shown in FIG. 1.

If the cross-section area of the thick element 26 is less than 0.1 time the product E×T, the deformation of the bead seat portion 24B′ can not be effectively prevented to thereby suffer deterioration of road noise. If the cross-section area of the thick element 26 is larger than 4.0 times the product E×T, it is undesirable as there is a problem such that the brake drum or the like of a vehicle is susceptible to interference of the thick element 26.

Note here that the thickness Ft of the rim flange 22B is a thickness of a rim flange portion 22B 2 which extends in a direction orthogonal to the center axis O of rotation of the wheel. The wheel width direction length Ew of the bead seat portion 24B′ is a wheel width direction length between the inner side surface 22B 3 of the rim flange portion 22B2 and an intersection point P between the radially outer surface 24B′ 1 of the bead seat portion 24B′ located between the hump 25B and rim flange 22B, and the outer face 25B1 of the hump 25 protruding from the bead seat 24B. The thickness T of the portion 21X of the rim body 21 is a length in a direction perpendicular to the center axis O of rotation of the wheel at an intersection point Q between the radially outer surface 21A of the rim body 21 on the vehicle outer side of the hump 25B when attached to the vehicle, and the outer face 25B1 of the hump 25B.

The present invention is preferably applicable to wheels used particularly for a pneumatic tire for a passenger car.

### EXAMPLE

Prepared were wheels of the present invention 1 to 8 and prior art 1 and 2 having the same rim size of 15×6½JJ. The present invention wheels 1 to 7 having constructions shown in FIGS. 1 to 3 in which the wheels, formed of an alloy of aluminum, had a thinner disk and rim thickness and the thick element thereof formed of an alloy of aluminum was integrally formed on the bead seat portion of each of the wheels, the present invention wheels 8 having a construction shown in FIG. 4 in which the wheels, formed of an alloy of aluminum, had a thinner disk and rim thickness and a ring member formed of an alloy of magnesium was welded to form the thick portion thereof, the prior art wheels 1, formed of an alloy of aluminum, having a construction which was not thinner in thickness and had no thick element, the prior art wheels 2 having the same construction as the prior art wheels 1 except that the disk and rim thereof were thinner in thickness to thereby lighten the wheels.

The cross-section area of the thick element of each present invention wheel was shown in Table 1. The cross-section area of each thick element in Table 1 was represented in a ratio to the product E×T. The thick element stat position in Table 1 was a distance (mm) in a width direction of the wheel from the intersection point P to the thick element. The thick element end position was a distance (mm) in a width direction of the wheel from the outer side surface 22B1 of the rim flange 22B to the thick element.

Evaluation tests for weight and road noise were conducted on each test wheel in accordance with the following measurement methods. The results shown in Table 1 were obtained.

Weight

The weight of each test wheel was measured. The measurement result was evaluated by an index number, with the index number of the prior art wheel 1 being 100. The smaller the index number was, the lighter the wheel.

Road Noise

Each group of test wheels on which tires having a tire size of 195/60R15 were mounted with their air pressure being 200 kPa were attached to a front-wheel-drive passenger car with a displacement of 2 liters, and a feeling test was conducted by five test drivers in a test course with the passenger car driven by each test driver. Each result of the feeling test was evaluated by 5-point method which increased or decreased by 0.5 point. The mark of road noise was an average value of evaluation by the five test drivers, which was rounded to meet the 5-point method. The greater the value was, the lower the road noise. The mark having “+” meant that it was somewhat superior to the same mark.

TABLE 1

| | | Thick | Thick | | | | |
|---|---|---|---|---|---|---|---|
| | | Element | Element | | Material | | |
| | Thick Element | Start | End | Thick | Except | Weight | |
| | Cross-Section | Position | Position | Element | Thick | (Index | Road |
| | Area Ratio | (mm) | (mm) | Material | Element | Number) | Noise |
| Prior Art | — | — | — | — | Aluminum | 100 | 3+ |
| Wheel 1 | | | | | Alloy | | |
| Prior Art | — | — | — | — | Aluminum | 75 | 2 |
| Wheel 2 | | | | | Alloy | | |
| Present | 0.1 | 0 | 3 | Aluminum | Aluminum | 75 | 3+ |
| Invention | | | | Alloy | Alloy | | |
| Wheel 1 | | | | | | | |
| Present | 0.1 | 3 | 0 | Aluminum | Aluminum | 75 | 3+ |
| Invention | | | | Alloy | Alloy | | |
| Wheel 2 | | | | | | | |
| Present | 0.25 | 0 | 3 | Aluminum | Aluminum | 76 | 3.5 |
| Invention | | | | Alloy | Alloy | | |
| Wheel 3 | | | | | | | |
| Present | 0.25 | 3 | 0 | Aluminum | Aluminum | 76 | 3.5 |
| Invention | | | | Alloy | Alloy | | |
| Wheel 4 | | | | | | | |
| Present | 0.25 | 3 | 3 | Aluminum | Aluminum | 76 | 3.5 |
| Invention | | | | Alloy | Alloy | | |
| Wheel 5 | | | | | | | |
| Present | 4 | 0 | 3 | Aluminum | Aluminum | 88 | 4 |
| Invention | | | | Alloy | Alloy | | |
| Wheel 6 | | | | | | | |
| Present | 0.25 | 0 | 0 | Aluminum | Aluminum | 76 | 3.5 |
| Invention | | | | Alloy | Alloy | | |
| Wheel 7 | | | | | | | |
| Present | 0.25 | 0 | 0 | Magnesium | Aluminum | 76 | 4 |
| Invention | | | | Alloy | Alloy | | |
| Wheel 8 | | | | | | | |

As can be seen from Table 1, the present invention wheels do not deteriorate road noise unlike the prior art wheel 2 which reduced weight, while lighter than the prior art wheel 1.

As illustrated above, according to the present invention, a ling-like thick element extending along a circumferential direction of the wheel is provided on the bead seat portion, and therefore, the wheel can be lightened without suffering deterioration of road noise.

### INDUSTRIAL APPLICABILITY

The tire wheel of the present invention having the aforementioned excellent effect can be used very effectively as a tire wheel which is to be attached to a vehicle.

1. A tire wheel having a disk and a rim for mounting a pneumatic tire joined to a peripheral edge of the disk, the rim having left and right cylindrical bead seats with a hump which protrudes thereon and left and right annular rim flanges joined to and extending wheel-radially outwardly from outer side edges of the bead seats,
wherein a ring-like thick element extending along a circumferential direction of the wheel is provided on a portion of the bead seat located between the hump and rim flange of the rim located on the inner side of a vehicle when attached thereto.

2. A tire wheel according to claim 1, wherein a cross-section area of the thick element is 0.1 to 4.0 times larger than the cross-section area represented by a product E×T in a wheel-radial cross section taken along a plane which passes through an axis of rotation of the wheel, wherein E is a sum of a thickness Ft of the rim flange located on the inner side of a vehicle when attached thereto and a wheel width direction length Ew of the bead seat portion, and T is a thickness of a portion of the rim body adjacent to the hump located on the inner side of a vehicle when attached thereto.

3. A tire wheel according to claim 1, wherein the thick element is provided on a radially inner side of an outer side end of the bead seat portion opposed to the rim flange.

4. A tire wheel according to claim 1, wherein the thick element is unitarily formed on a radially inner side of the bead seat portion.

5. A tire wheel according to claim 1, wherein the thick element is formed from a ring member which is fixed to a radially inner side of the bead seat portion.

6. A tire wheel according to claim 5, wherein the ring member is formed of a material which is lower in specific gravity and/or has a rigidity higher than that of the bead seat.

7. A tire wheel according to claim 6, wherein the ring member is formed of an alloy of magnesium.

8. A tire wheel according to claim 1, wherein the disk and the rim are formed of lightweight metal.

9. A tire wheel according to claim 8, wherein the lightweight metal is an alloy of aluminum or magnesium.
